(19) United States
(12) Patent Application Publication
(10) Pub. No.: US 2008/0256057 A1
(43) Pub. Date: Oct. 16, 2008

(54) Optimizing a query using fuzzy matching

(76) Inventors: Soren Riise, Ruislip (GB); David Richardson-Bunbury, Streatham (GB)

Correspondence Address: BRINKS HOFER GILSON & LIONE / YAHOO! OVERTURE, P.O. BOX 10395, CHICAGO, IL, 60610, US

(21) Appl. No.: 11/786,547

(22) Filed: Apr. 12, 2007

(51) Int. Cl. G06F 17/30

(52) U.S. Cl. 707/5; 707/E17.108

(57) ABSTRACT

A system is disclosed for optimizing a user query. User queries often include issue terms, such as misspelled or mistyped terms. The disclosed system employs a fuzzy network to match an issue term with a valid term. The system optimizes the user query with the valid term. Thereafter, query results based on the optimized user query may be provided to the user.

### BACKGROUND

1. Technical Field

This application relates to search engines. In particular, this application relates to optimizing a query submitted to a search engine.

2. Related Art

The availability of powerful tools for developing and distributing Internet content has led to an increase in information, products, and services offered through the Internet, as well as a dramatic growth in the number and types of consumers using the Internet. To sift through this immense volume of information, a user often submits queries to search engines that provide responsive information meeting the criteria specified by the queries.

Queries may provide an important source of revenue for e-commerce enterprises, such as Internet-based search engines, advertisers, etc. E-commerce enterprises provide results to a user based on the user's submitted query terms or other relevant information. In this manner, such enterprises may provide advertising and other information or content to the user. In addition, some enterprises may provide results to topic-specific queries, such as on web-sites for searching geographic related listings, an electronics store, a web-doctor, or any number of other online services.

However, a user query may not always result in an exact relevant match, such as when a user misspells or mistypes a word, often resulting in a user having to redefine, re-type, or abandon the search. The search results should correspond to the term or terms the user intended to search for even though the original query contained one or more incorrectly typed terms.

A need therefore exists for an accurate and efficient system for providing search results which correspond to the term or terms the user intended to search for even though the original query contained one or more unmatched terms.

### BRIEF SUMMARY

A system is disclosed for optimizing a user query. The disclosed system employs a fuzzy network to match an issue term, such as a misspelled or mistyped term, with a valid term. The system may optimize the user query with the valid term. Thereafter, query results based on the optimized user query may be provided to the user.

The system generates a fuzzy network from a set of valid terms. The fuzzy network includes terms from the set of valid terms networked together as multiple networked terms. Each networked term of the fuzzy network is a neighbor to at least one other networked term. The set of valid terms may be networked together using a string similarity function to enable efficient navigation of the fuzzy network when searching for valid matches to an issue term.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, with an emphasis instead being placed upon illustrating the principles of the invention. Moreover, in the figures, like-referenced numerals designate corresponding parts throughout the different views.

FIG. 1 shows an architecture for optimizing a query according to one embodiment.

FIG. 2 shows a more detailed representation of the architecture for optimizing a query of FIG. 1 including a matching processor coupled with a networking processor.

FIG. 3 shows an exemplary process for optimizing a query, according to one embodiment.

FIG. 4 shows a more detailed diagram depicting an exemplary process of applying the issue term to the fuzzy network.

FIG. 5 shows a graph of an exemplary fuzzy network including networked terms for use with the disclosed embodiments.

FIG. 6 is a flow diagram illustrating an exemplary application of a received issue term to the fuzzy network of FIG. 5.

FIG. 7 shows an exemplary process for generating a fuzzy network according to one embodiment.

FIG. 8 illustrates a computer system implementing a fuzzy matching system, including a processor coupled with a memory, according to one embodiment.

### DETAILED DESCRIPTION

User queries submitted to search engines may not always result in an exact relevant match, such as when a user misspells or mistypes a word, often resulting in a user having to redefine, re-type, or abandon the search. The search results should correspond to the term or terms the user intended to search for even though the original query contained one or more incorrectly typed terms. Fuzzy matching systems are sometimes used to locate, for example, the correctly-spelled search term. Fuzzy matching systems, however, are often expensive and inefficient and involve a large number of comparisons to find a correctly-spelled term. On the other hand, faster fuzzy matching systems often sacrifice accuracy for the increased speed.

The disclosed embodiments relate generally to fuzzy matching. The principles described herein may be embodied in many different forms. The disclosed systems and methods may allow search engines or other e-commerce entities to provide a user with relevant information based on the user's search query, even where the user mistyped or misspelled a search term. The disclosed systems and methods may minimize the amount of input and search refinements a user must provide before receiving relevant search results by matching an issue term, such as a misspelled or mistyped term, with the term the user intended to search for. Further, the disclosed systems and methods may minimize the processing sets used to locate a correctly spelled term that corresponds to an issue term. For the sake of explanation, the system is described as used in a network environment, but the system may also operate outside of the network environment.

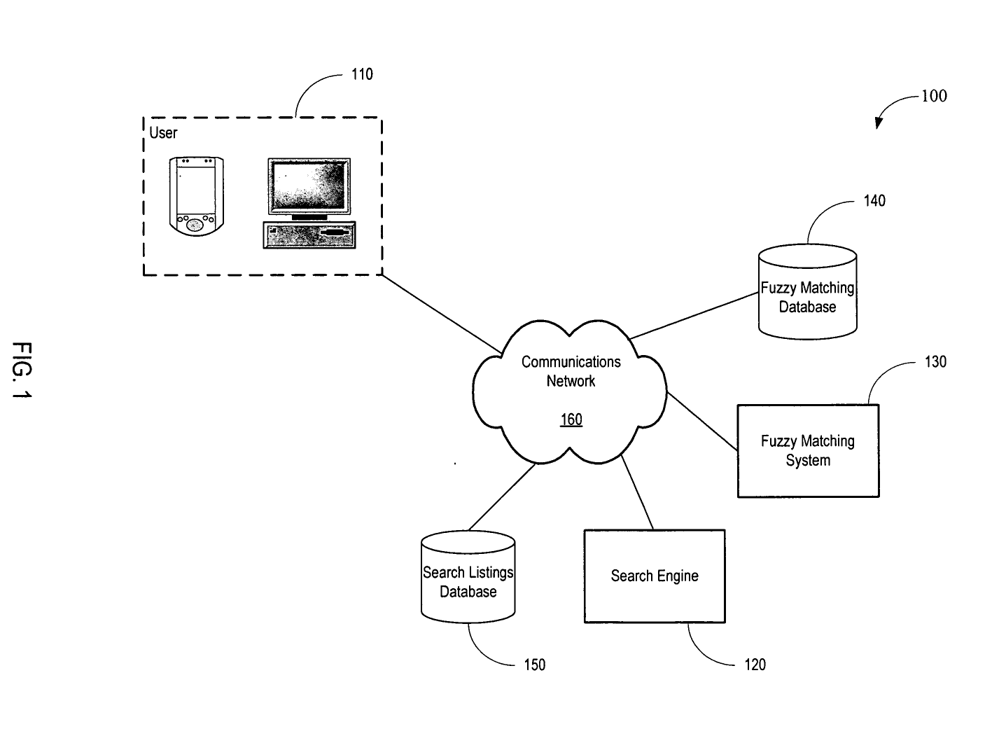

FIG. 1 shows an architecture 100 for optimizing a query according to one embodiment. The architecture 100 may includes a user client system 110, a search engine 120, a fuzzy matching system 130, a fuzzy matching database 140, and a search listings database 150. The user client system 110 may submit a query via a communications network 160 to the search engine 120, which may be implemented on a server or other network enabled system. It will be appreciated that the components of the architecture 100 may be separate, may be supported on a single server or other network enabled system, or may be supported by any combination of servers or network enabled systems.

The communications network 160 may be any private or public communications network or combination of networks. The communications network 160 may be configured to couple one computing device, such as a server, system, database, or other network enabled device, to another device to enable communication of data between computing devices. The communications network 160 may generally be enabled to employ any form of computer-readable media for communicating information from one computing device to another. The communications network 160 may include one or more of a wireless network, a wired network, a local area network (LAN), a wide area network (WAN), a direct connection such as through a Universal Serial Bus (USB) port, and the like, and may include the set of interconnected networks that make up the Internet. The communications network 160 may include any communication method by which information may travel between computing devices.

The search engine 120 may be a general search engine, a meta-search engine, specialized search engine, a directory, or other system that locates user requested information or files on the Internet. The search engine 120 may be adapted to search the listings of topic-specific individual websites, such as a medical services website, an online electronics store, an online bookstore, a geographic listings website, or any number of other websites to which the user client system 110 may submit a query.

The user client system 110 may connect to the search engine 120 via the Internet using a standard browser application. A browser-based implementation allows system features to be accessible regardless of the underlying platform of the user client system 110. For example, the user client system 110 may be a desktop, laptop, handheld computer, cell phone, mobile messaging device, network enabled television, digital video recorder, such as TIVO, automobile, or other network enabled user client system 110, which may use a variety of hardware and/or software packages. The user client system 110 may connect to the search engine using a stand-alone application which may be platform-dependent or platform-independent. Other methods may be used to implement the user client system 110.

The query submitted by the user client system 110 may include one or more issue terms. A term may be a word, phrase, group of characters, or any other set of data submitted as part of a query. An issue term may be a term for which the search engine 120 and/or fuzzy matching system 130 generate few if any results. For example, upon receiving a query, the search engine 120 may search the search listings database 150 for listings that match the user query. An issue term may a term that matches or is otherwise associated with few to none of the terms located within the searched listings. An issue term may be, for example, a term that is misspelled, mistyped, improperly used, slang, in a foreign language, or otherwise submitted in such a way that few if any results to the query, or matches to the issue term, are found.

The fuzzy matching system 130 may receive the query, or the issue term, from the search engine 120 directly or via the communications network 160. The fuzzy matching system 130 may also receive the query, or the issue term, from the user client system 110. The fuzzy matching system 130 applies the issue term to a fuzzy network to identify a valid term that corresponds to the issue term submitted by the user client system 110. The fuzzy network may be stored in the fuzzy matching database 140.

The fuzzy matching system 130 identifies the valid term and may provide the valid term to the search engine 120. The fuzzy matching system 130 may also optimizes the query with the valid term and provide the optimized query to the search engine 120. Optimizing the query may include replacing the misspelled or mistyped term with the valid term.

The fuzzy matching system 130 may generate search results based on the optimized query, or it may pass the optimized query to the search engine 120 for generating search results. The search engine 120 may include the search listings database 150 for storing the information to be searched based on the optimized query. The fuzzy matching system 130 may connect to the search listings database 150 directly or via the communications network 160. The fuzzy matching system 130 and/or the search engine 120 may also include a Web server that delivers Web pages or other files that may include responsive search results to browsers or other applications.

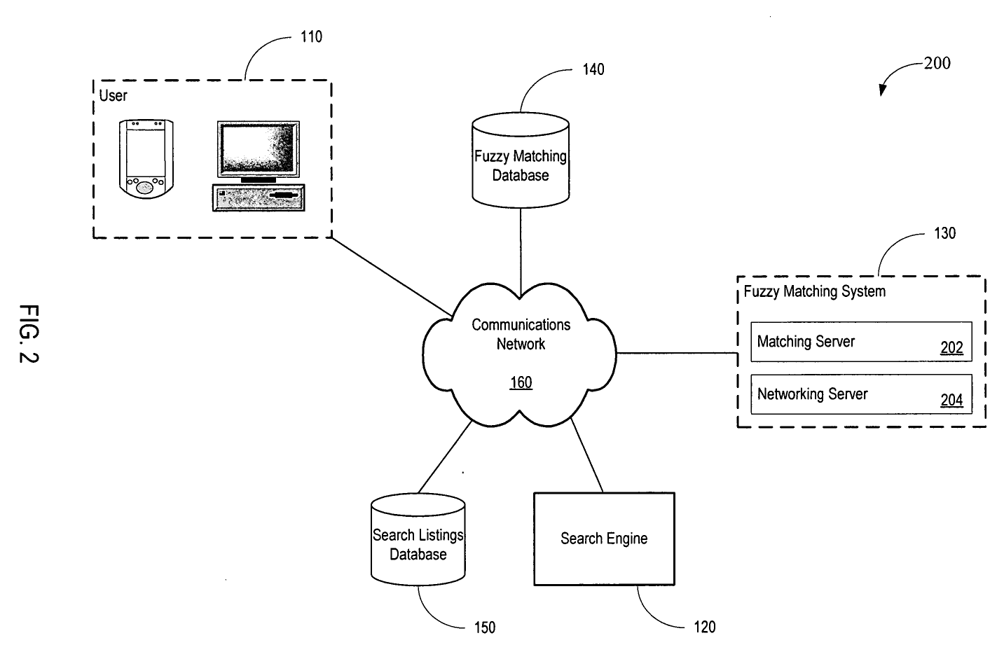

FIG. 2 shows a more detailed representation of the architecture 200 for optimizing a query including a matching processor 202 coupled with a networking processor 204. Herein, the phrase “coupled with” is defined to mean directly connected to or indirectly connected through one or more intermediate components. Such intermediate components may include both hardware and software based components. The architecture 200 may include a user client system 110, a search engine 120, a fuzzy matching system 130, a fuzzy matching database 140, and a search listings database 150, similar to those described above and shown in FIG. 1. The fuzzy matching system 130 may include the matching processor 202 and networking processor 204.

The matching processor 202 may receive the query, or one or more issue terms of the query, and access a fuzzy network to match or otherwise associate an issue term with a valid term. The matching processor 202 may provide the valid term to the search engine 120. Based on the valid term, the matching processor 202 may optimize the query to increase the likelihood that the user will be presented with the most relevant query results. The matching processor 202 may provide the optimized query and/or the valid term to the search engine 120 directly or via a communications network 160.

The networking processor 204 may generate the fuzzy network used to match an issue term with a valid term. The networking processor 204 may generate the fuzzy network from a set of valid terms. For each term in the set of valid terms, the networking processor 204 identifies which of the other terms in the set are neighbors of that term. The fuzzy network may accordingly include multiple networked terms, where each networked term has at least one neighboring term. Each networked term of the fuzzy network may be connected to each other networked term through one or more intermediary neighbors, or by virtue of being neighbors of each other.

The set of valid terms used to generate the fuzzy network may be provided by the search engine 120 or by another third-party system. The networking processor 204 may also create the set of valid terms. The networking processor 204 may create the set of valid terms using technical, medical, general, or other dictionaries, atlases, gazetteers, or other resources.

The networking processor 204 may update the fuzzy network. For example, if the search engine 120 supplements the set of valid terms, the networking processor 204 may generate a new fuzzy network, or supplement an existing fuzzy network.

It will be appreciated that each of the matching processor 202 and the networking processor 204 may be separate processors, integrated together, or further sub-divided into additional discrete components. It will further be appreciated that the matching processor 202 and the networking processor 204 may be implemented on the same or separate servers or other network-enabled devices. All logical and physical implementations of the described functionality are contemplated herein.

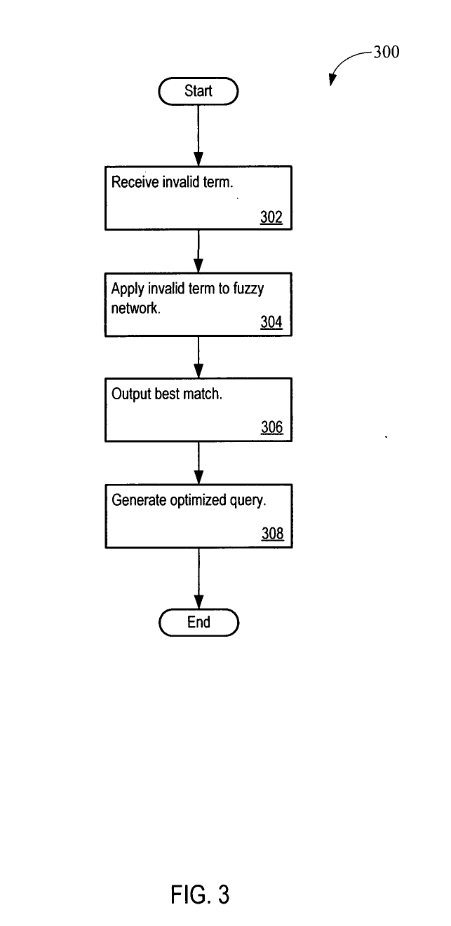

FIG. 3 shows an exemplary process 300 for optimizing a query, according to one embodiment. The process 300 receives an issue term (Block 302). The issue term may correspond to one or more components of a user query submitted to a search engine, searchable database, or other search application that provides results in response to the user query. The search application may determine if the user query includes an issue term. The process 300 may receive the issue term from the search application. In another exemplary embodiment, the process 300 may receive the user query and determine whether the user query includes one or more issue terms.

An issue term may be a term that was misspelled or mistyped by the user. For example, the user, intending to search for “dentists in Washington,” may have typed “dentists in Whasington.” The term “Whasington,” in this example, may correspond to the issue term.

The process 300 applies the issue term to a fuzzy network (Block 304) to identify a valid term that best matches the issue term. The fuzzy network includes multiple networked terms, each networked term having at least one neighbor. Each neighbor of a networked term is another networked term of the fuzzy network, which in turn also has at least one neighbor. Each networked term of the fuzzy network corresponds to a valid term from among a set of valid terms. In other words, the fuzzy network is a networked set of valid terms. As an example, one of the valid terms in the set of valid terms may be “Washington.”

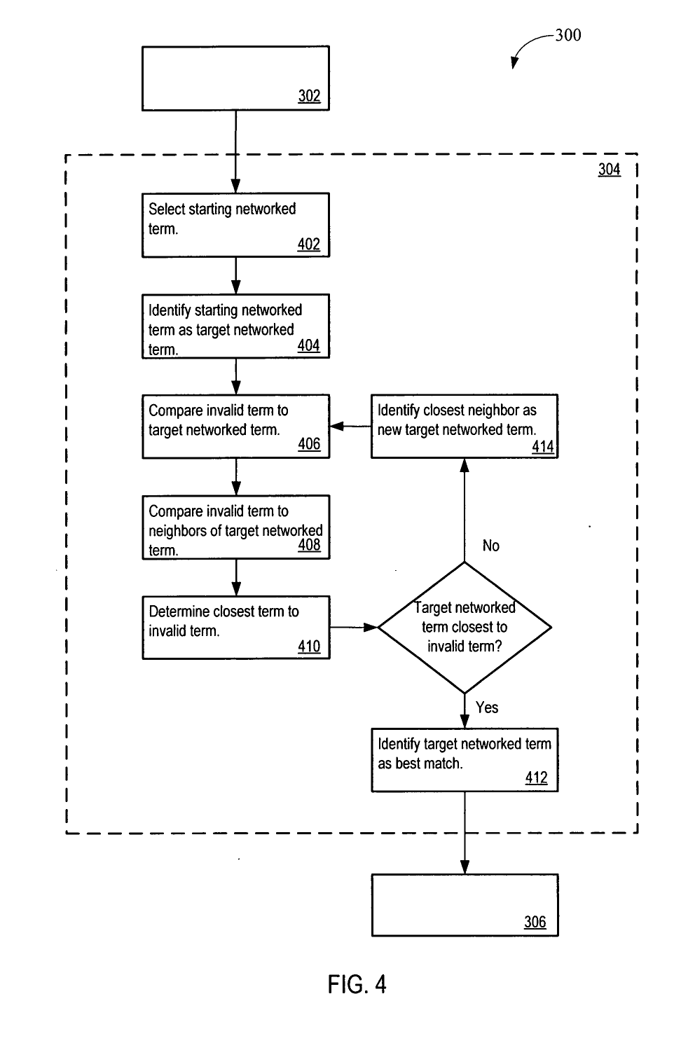

FIG. 4 shows a more detailed diagram depicting an exemplary process of applying the issue term to the fuzzy network. The process 300 may select a starting networked term (Block 402). The starting networked term may be a pre-determined start term. The pre-determined start term may be optimally selected to minimize the number of processing steps needed to match the issue term with a valid term. For example, the pre-determined start term may be a term centrally located in the fuzzy network. The process 300 may analyze the issue term to optimize selection of the starting networked term. For example, the process 300 may select a starting networked term such that the starting networked term starts or ends with the same character or combination of characters as the issue term. The starting networked term may also be selected arbitrarily. Other methods may be used to optimize selection of the starting networked term.

The process 300 may identify the starting networked term as a target networked term (Block 404). The process 300 compares the issue term to the target networked term (Block 406). The process 300 may compare the issue term to the target networked term using a string similarity function. For example, the process 300 may use a Ratcliff/Obershelp, Levenshtein, or other function for measuring string distance. The process 300 compares the issue term to the neighbors of the target networked term (Block 408). In comparing the issue term to the neighbors, the process 300 may use the same string similarity function used to compare the issue term to the target networked term.

Based on the results of the comparisons in Blocks 406 and 408, the process 300 may determine which term, from among the target networked term and the neighbors of the target networked term, is closest to the issue term (Block 410). If the target networked term is closest to the issue term, the process identifies the target networked term as a best match to the issue term (Block 412).

The process 300 may also identify alternative best matches. Alternative best matches may be, for example, the neighbors of the term identified as the best match.

If one of the neighbors of the target networked term is closest to the issue term, the process identifies that neighbor as the new target networked term (Block 414) and repeats Blocks 408-410 until the target networked term is closer to the issue term than any of the target networked term's neighbors, i.e., until the best match is found.

In the example above in which the issue term was “Whasington,” one of the networked terms may be “Washington.” Irrespective of which networked term the process 300 started with, the process 300 would eventually identify “Washington” as the best match by proceeding from neighbor to neighbor until the target networked term that is closest to the issue term is identified.

Referring again to FIG. 3, the process 300 outputs the best match (Block 306). The process 300 may output the identified best match to the search application. The process 300 may also output the alternative best matches.

The process 300 may also generate an optimized user query (Block 308). The process 300 may substitute the issue term that was part of the original query with identified best match. The process 300 may output the optimized user query to the search application. The process 300 may also display, or enable the search application to display, the best match and/or alternative best matches to the user. The process 300 or search application may request or enable the user to select whether to modify the query with the best match and/or an alternative best match, or to proceed with the query originally entered.

The process 300 may be configured to automatically optimize the query under certain defined conditions. In one embodiment, the process 300 may obtain a string similarity value that represents how similar the best match is to the issue term. If the string similarity value is below a first threshold, suggesting that the best match is very similar to the issue term, the process 300 may automatically substitute the best match for the issue term. In another embodiment, the process 300 may enable the user to choose whether the query should include the best match or the issue term if the string similarity value is below a second threshold, but above the first threshold. In another embodiment, the process 300 may enable the user to choose whether the query should include the best match, an alternative best match, or the issue term if the string similarity value is above the second threshold.

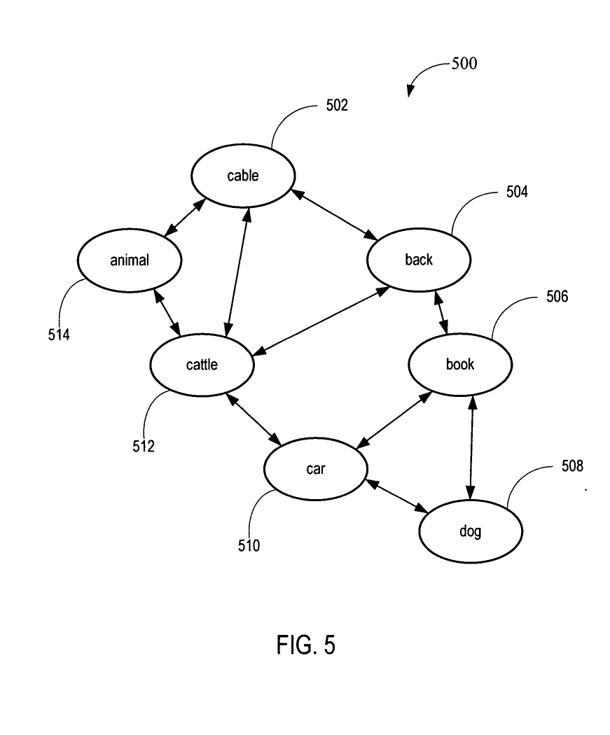

FIG. 5 shows a graph of an exemplary fuzzy network 500 including networked terms 502-514 for use with the disclosed embodiments. The lead lines between the networked terms 502-514 indicate which networked terms are neighbors to each other networked term. For example, the networked term “cable” 502 has neighbors “animal” 514, “cattle” 512, and “back” 504. It will be appreciated that the networked terms 502-514 may have different neighbors in different fuzzy networks depending in part on the type of string similarity function used to generate the fuzzy network.

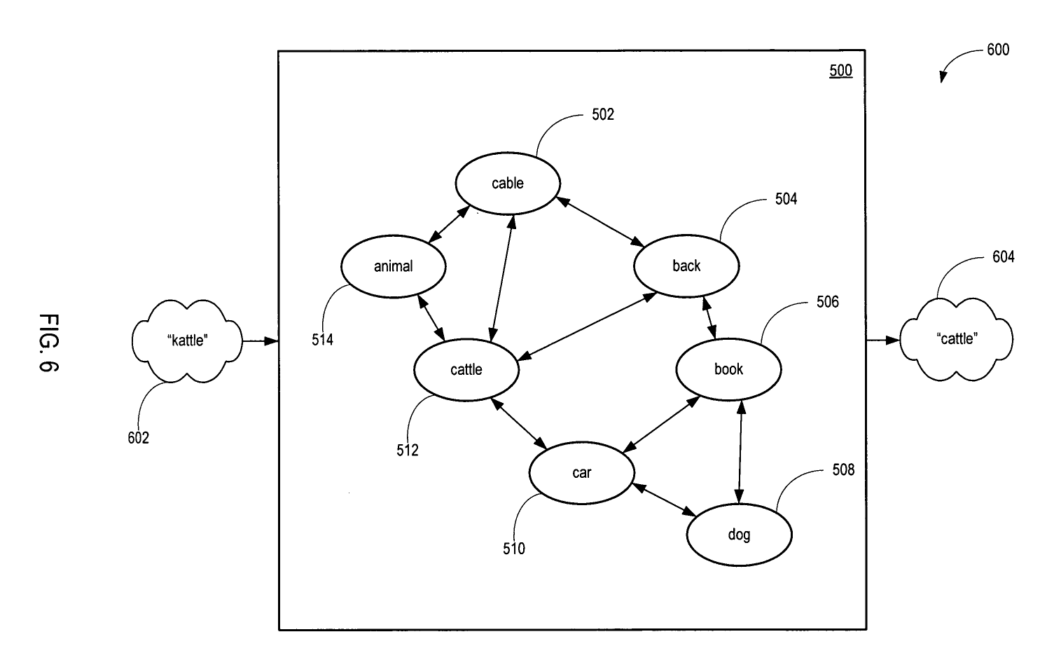

FIG. 6 is a flow diagram 600 illustrating an exemplary application of a received issue term 602 to the fuzzy network 500 of FIG. 5. The process 300, or another process, may be used to apply an issue term 602 to the fuzzy network 500 and to identify a corresponding valid term 604. For the sake of explanation, application of the issue term 602 to the fuzzy network 500 will be described in terms of one or more of the steps performed by the process 300.

The process 300 receives the issue term “kattle” 602 and applies the term 602 to the fuzzy network 500. The process 300 determines a starting networked term and identifies the starting networked term as a target networked term. The process starts with, for example, “dog” 508 and identifies “dog” as the target networked term. The process 300 compares “kattle” 602 to the “dog” 508 and to the neighbors of “dog” 508, i.e., “car” 510 and “book” 506. As discussed above, the process 300 may use one or more string similarity functions to compare terms. For example, the string similarity function may be a string distance function that determines a string distance between terms.

The process 300 may determine that the term “car” 510, one of the neighbors of “dog” 508, is closest to “kattle” 602. The process 300 may accordingly set “car” 510 as the new target networked term. The process 300 compares “kattle” 602 to the new target networked term, “car” 510, and to the neighbors of the new target networked term, i.e., “book” 506, “dog” 508, and “cattle” 512. However, the process 300 already compared the issue term 602 to “car” 510, as well as to two of the neighbors of “car” 510, i.e., “book” 506 and “dog” 508. The process 300 may track which terms of the fuzzy network have already been compared to the issue term 602 and store a text similarity value between terms. The text similarity value may be the result of the string similarity function used to compare the issue term 602 with the networked terms as the process 300 proceeds through the fuzzy network 500.

It will be appreciated that as the process 300 proceeds through a fuzzy network, the process 300 may optionally ignore past target networked terms and/or common neighbors between a past target networked term and a current target networked term. For example, the process 300 already compared “kattle” 602 to two of the neighbors of “car” 510 and identified “car” 510 as the new target networked term because it was closer to “kattle” 602 than was “book” 506 or “dog” 508. In this example, the process 300 may ignore “dog” 508 and/or “book” 506 when considering the text similarity between “kattle” 602 and “book” 506 and “dog” 508.

With “car” 510 as the new target networked term, the process 300 determines the neighbor “cattle” 512 is closest to “kattle” 602 and accordingly identifies “cattle” 512 as the new target networked term. The process 300 repeats the above steps and determines that the new target networked term “cattle” 512 is closer to “kattle” 602 than are any of the neighbors of “cattle” 512. The process 300 accordingly identifies “cattle” 512 as the valid term 604 that best matches the issue term 602. It will be appreciated that the process 300 would have ended up at the networked term “cattle” 512 regardless of which term of the fuzzy network 500 the process 300 started with.

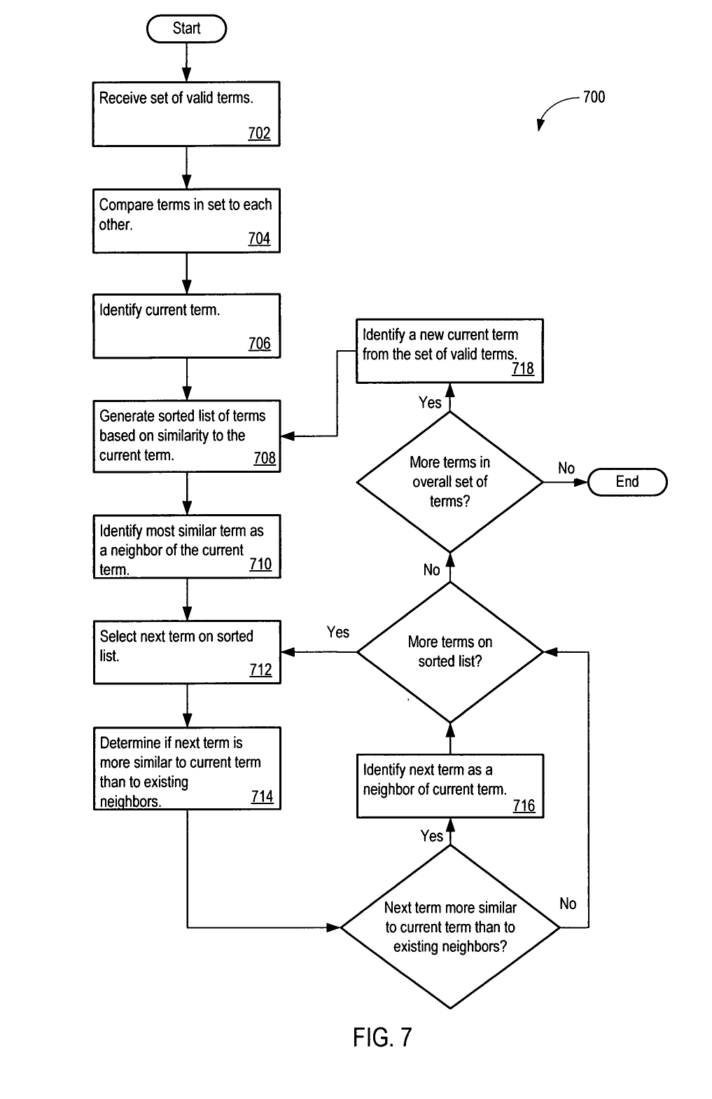

FIG. 7 shows an exemplary process 700 for generating a fuzzy network according to one embodiment. The process 700 receives a set of valid terms (Block 702). The set of valid terms may be a set of properly typed and spelled terms against which a fuzzy matching process may match an issue term with a corresponding valid term. The process 700 may receive the set of valid terms from a search application. The set of valid terms may be tailored to a specific search application. For example, an electronics store that maintains a searchable website may provide a set of valid terms that relate to the electronics business. The set of valid terms may be a set of geographic-type terms provided by a location-finding website, or a set of medical related terms for a web-doctor website. The set of valid terms may be tailored to a searchable database provided by a standalone application. The set of valid terms may be a set of general or common terms for a general search engine. In general, the set of valid terms may be tailored to the needs, requirements, and/or specifications of a search application.

In another embodiment, the process 700 may generate the set of valid terms. The process 700 may receive specifications from a search application and tailor the set of valid terms to the specifications. The process 700 may generate the set of valid terms from general, technical, medical, or other types of dictionaries, encyclopedias, atlases, or other reference sources.

The process 700 compares each term in the set to each other term in the set (Block 704). The process 700 may use a string similarity function as described above. The process 700 may store results of the comparisons in a database, lookup table, or other data storing system.

The process 700 identifies a current term in the set of terms (Block 706). The process 700 generates a sorted list of valid terms based on each term's similarity to the current term (Block 708). For example, the sorted list may include the set of valid terms sorted from most similar to least similar, as compared to the current term. The sorted list may be a pool of potential neighbors of the current term.

The process 700 identifies the most similar term in the ordered list as a neighbor of the current term (Block 710). The process 700 selects a next term on the ordered list (Block 712). The process 700 may select terms from the ordered list in order from the most similar term to the least similar term, as compared to the current term. The process 700 determines whether the next term is more similar to the current term than it is to any identified neighbors of the current term (Block 714). As noted above, the results of the comparisons of Block 704 may be stored in a database, lookup table, or other storing system. The process 700 may look up data corresponding to the similarity or distance between terms of the set of valid terms.

If the next term is more similar to the current term than it is to any of the identified neighbors of the current term, the process 700 identifies the next term as another neighbor of the current term (Block 716). If the next term is more similar to any of the existing neighbors of the current term than to the current term itself, the next term is not identified as a neighbor of the current term. In either case, if the process 700 has not evaluated all the terms on the ordered list to determine if each should be identified as a neighbor of the current term, the process 700 selects a next term on the ordered list according to Block 712 and repeats Block 714, as well as Block 716 to the extent the next term is more similar to the current term than to any of the current term's identified neighbors.

If the process 700 has evaluated all the terms on the ordered list to determine if each should be identified as a neighbor of the current term, the process 700 determines if each term in the set of valid terms has been networked, i.e., if the neighbors of each term in the set of valid terms have been identified. If the process 700 has not networked all the terms in the set of valid terms, the process 700 sets a new term as the current term (Block 718) and repeats Blocks 708-716.

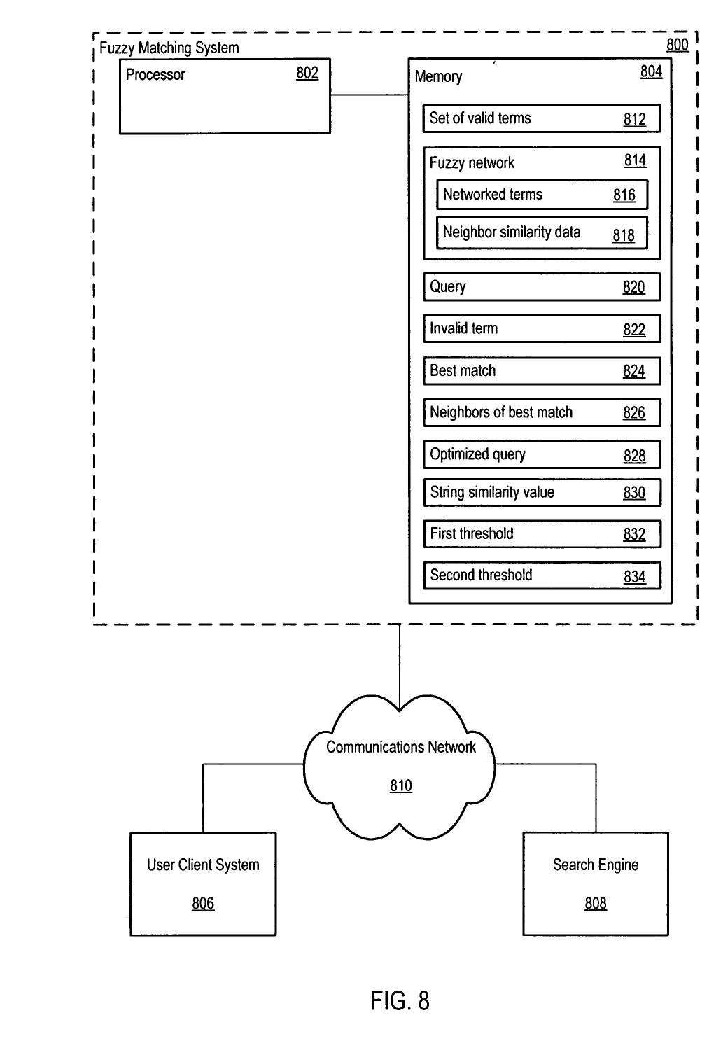

FIG. 8 illustrates a computer system implementing a fuzzy matching system 800, including a processor 802 coupled with a memory 804, according to one embodiment. The processor 802 may execute instructions stored on the memory 804 to optimize a query. The fuzzy matching system 800 may communicate with a user client system 806 and/or a search application 808 via a communications network 810.

The memory 804 may store a set of valid terms 812. The fuzzy matching system 800 may receive the set of valid terms 800 from the user client system 806, the search application 808, or from a third party source. The fuzzy matching system 800 may generate a fuzzy network 814 based on the set of valid terms 812. The fuzzy network 814 may include multiple networked terms 816, each networked term 816 corresponding to at least one of the terms in the set of valid terms 812. In addition, each networked term 816 is a neighbor to at least one other networked term 816. The fuzzy network 814 may also include neighbor similarity data 818. The neighbor similarity data 818 may be a value that indicates the similarity between neighboring terms. For example, where a Levenshtein distance function was used to generate the fuzzy network 814, the neighbor similarity data 818 may include a Levenshtein distance between, for example, each networked term 816 and its neighbor.

The memory 804 may store a query 820 submitted by the user client system 806 to the search application 808. The fuzzy matching system 800 may receive the query 820 from the user client system 806 and/or from the search application 808 via the communications network 810. The fuzzy matching system 800 may also receive an issue term 820 from the user client system and/or from the search application 808. The issue term 822 may be a term that has few if any matches among the listings searched by the search application 808. For example, the issue term may be a misspelled or mistyped term.

The system 800 and/or the search engine 808 may identify whether the query 820 includes an issue term 822 and store the issue term 822 in the memory 804. The system 800 and/or the search engine 808 may determine whether there are any matches for the query 820. The system 800 and/or search engine 808 may use a hashing function to determine whether the query 820 will produce any results. If the system 800 and/or search engine 808 determine that there are no matches, or a small number of matches, the system 800 and/or search engine 808 may identify one or more terms of the query 820 that generated little or no results as the issue term(s) 822.

The fuzzy matching system 800 may apply the issue term 822 to the fuzzy network 814 to identify a best match 824 from among the networked terms 816. The fuzzy matching system 800 may also one or more alternative best matches 826. In one embodiment, alternative best matches 826 may be neighbors of the best match 824. The memory 804 may store the best match 824 and the alternative best matches 826.

The fuzzy matching system 800 may generate an optimized query 828 based on the best match 824 and/or the alternative best matches 826. The fuzzy matching system 800 may substitute the issue term 822 that was part of the original query with best match 824. The fuzzy matching system 800 may output the optimized query 828 to the search engine 808. The system 800 may also display, or enable the search application to display, the best match 824 and/or alternative best matches 826 to the user client system 806. The system 800 and/or search engine 808 may request or enable the user client system 110 to select whether to modify the query 820 with the best match 824 and/or an alternative best match 826, or to proceed with the query 820 originally submitted.

The system 800 may obtain a string similarity value 830 that may represent how similar the best match 824 is to the issue term 822. The memory 804 may store the string similarity value 830. The system 800 may compare the string similarity value 830 to one or more thresholds stored in the memory 804. In one embodiment, if the string similarity value 830 is below a first threshold 832 stored in the memory, suggesting that the best match 824 is very similar to the issue term 822, the system 800 may automatically optimize the query 820 by substituting the best match 824 for the issue term 822. In another embodiment, if the string similarity value 830 is below a second threshold 834 stored in the memory 804, but above the first threshold 832, the system 800 may enable the user client system 806 to choose whether the query 820 should include the best match 824 or the issue term 822. In another embodiment, if the string similarity value 830 is above the second threshold 834, the system 800 may enable the user client system 806 to choose whether the query 820 should include the best match 824, an alternative best match 826, or the issue term 822.

From the foregoing, it can be seen that the present invention provides improved search quality by efficiently and accurately matching issue terms, such as invalid query terms, with a valid term that, when inserted in the original user query, will enable the search application to provide responsive results. In particular, the present invention provides improved search quality for user queries that may have few if any exact matches. Such queries often result in dissatisfied users having to refine or abandon the search. The present invention improves user satisfaction by providing, or enabling a search engine to provide, relevant search results to the user even if those relevant results did not exactly match the user's original query.

Although selected aspects, features, or components of the implementations are depicted as being stored in memories, all or part of the systems, including the methods and/or instructions for performing such methods consistent with the fuzzy matching system, may be stored on, distributed across, or read from other computer-readable media, for example, secondary storage devices such as hard disks, floppy disks, and CD-ROMs; a signal received from a network; or other forms of ROM or RAM either currently known or later developed.

Specific components of a fuzzy matching system may include additional or different components. A processor may be implemented as a microprocessor, microcontroller, application specific integrated circuit (ASIC), discrete logic, or a combination of other types of circuits or logic. Similarly, memories may be DRAM, SRAM, Flash, or any other type of memory. Parameters, databases, networks, and other data structures may be separately stored and managed, may be incorporated into a single memory or database, or may be logically and physically organized in many different ways. Programs or instruction sets may be parts of a single program, separate programs, or distributed across several memories and processors.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for optimizing a query comprising:
receiving an issue term of the query;
applying the issue term to a fuzzy network, the fuzzy network comprising a plurality of networked terms, each networked term of the plurality of networked terms being associated with one or more neighboring networked terms of the plurality of networked terms; and
identifying one networked term of the plurality of networked terms as a best match if the issue term is more similar to the one networked term than to any of the neighboring networked terms associated therewith.

2. The method of claim 1, where applying the issue term to a fuzzy network comprises:
identifying one networked term of the plurality of networked terms as a target networked term;
comparing the issue term to the target networked term;
comparing the issue term to each neighboring networked term associated with the target networked term;
identifying the target networked term as the best match if the issue term is more similar to the target networked term than to any of the neighboring networked terms associated therewith; and
setting a neighboring networked term that is most similar to the issue term as a new target networked term if the issue term is more similar to the neighboring networked term than to the target networked term.

3. The method of claim 2, where comparing the issue term to the target networked term comprises using a string distance function to determine a distance between the issue term and the target networked term.

4. The method of claim 2, further comprising:
selecting a starting networked term of the plurality of networked terms; and
identifying the starting networked term as the target networked term.

5. (canceled)

6. The method of claim 1, further comprising networking terms in a set of terms to generate the fuzzy network, where the set of terms is topic-specific.

7. The method of claim 1, further comprising networking terms in a set of terms to generate the fuzzy network, where networking the terms of the set in terms comprises:
identifying one of the terms in the set of terms as a current term;
generating a sorted list, where the sorted list comprises a list of terms in the set of terms arranged according to each term's similarity to the current term;
identifying a term in the sorted list that is most similar to the current term as a neighbor of the current term; and
for each term in the sorted list, proceeding according to each term's similarity to the current term:
comparing the term in the sorted list to each neighbor of the current term; and
identifying the term in the sorted list as a neighbor of the current term if the term in the sorted list is more similar to the current term than to any of the neighbors of the current term.

8. The method of claim 7, where comparing the term in the sorted list to each neighbor of the current term comprises using a string distance function to determine a distance between the term in the sorted list and each neighbor of the current term.

9. The method of claim 1, further comprising optimizing the query according to the best match.

10. The method of claim 9, where optimizing the query according to the best match comprises replacing the issue term in the query with the best match.

11. A system for optimizing a query, the system comprising:
a processor;
a memory coupled with the processor, the memory comprising instructions that cause the processor to:
receive an issue term of the query;
apply the issue term to a fuzzy network, the fuzzy network comprising a plurality of networked terms, each networked term of the plurality of networked terms being associated with one or more neighboring networked terms of the plurality of networked terms;
identify one networked term of the plurality of networked terms as a best match if the issue term is more similar to the one networked term than to any of the neighboring networked terms associated therewith; and
optimize the query according to the best match.

12. The system of claim 11, where the instructions that cause the processor to optimize the query according to the best match comprises instructions that cause the processor to replace the issue term in the query with the best match.

13. The system of claim 11, where the instructions that cause the processor to optimize the query according to the best match comprises instructions that cause the processor to provide a user with a choice between the query or the query in which the best match is substituted for the issue term.

14. (canceled)

15. The system of claim 11, where the instructions that cause the processor to optimize the query according to the best match comprise instructions that cause the processor to provide a user with at least one alternative query comprising a query in which the best match is substituted for the issue term.

16. The system of claim 11, where the instructions that cause the processor to optimize the query according to the best match comprises instructions that cause the processor to provide a user with at least one alternative query comprising a query in which a neighbor of the best match is substituted for the issue term.

17. The system of claim 11, where the instructions that cause the processor to apply the issue term to a fuzzy network comprise instructions that cause the processor to:
identify one of the plurality of networked terms as a target networked term;
determine the similarity between the issue term and the target networked term;
determine a similarity between the issue term to each neighboring networked term associated with the target networked term;
identify the target networked term as the best match if the issue term is more similar to the target networked term than to any of the neighboring networked terms associated therewith; and
set a neighboring networked term that is most similar to the issue term as a new target networked term if the issue term is more similar to at least one of the neighboring networked terms associated with the target networked term than to the target networked term.

18. A system for optimizing a query, the system comprising:
a networking processor operable to:
obtain a set of valid terms; and
generate a fuzzy network from the set of valid terms, where generating the fuzzy network comprises identifying one or more neighboring terms for each term in the set of valid terms, the fuzzy network comprising a plurality of networked terms, where each of the plurality of networked terms corresponds to at least one of the terms in the set of valid terms; and
a matching processor operable to:
receive on issue term of the query;
identify a valid term from the set of valid terms that best matches the issue term by applying the issue term to the fuzzy network; and
provide the valid term that best matches the issue term to a search application.

19. The system of claim 18, where identifying one or more neighboring terms for each term in the set of valid terms comprises:
for a given term in the set of valid terms:
determine a similarity between the given term and a plurality of other terms in the set;
generate a sorted list, the sorted list comprising a list of terms in the set arranged in order of similarity to the given term;
identify a term in the sorted list that is most similar to the given term as a neighboring term of the given term; and
for each remaining term in the sorted list, compare the remaining term in the sorted list to each neighboring term of the given term and identify the remaining term in the sorted list as a neighboring term of the given term if the remaining term is more similar to the given term than to any of the neighboring terms of the given term.

20. (canceled)

21. The system of claim 20, where the similarity between the given term and the plurality of other terms in the set is determined with a Levenshtein distance function.

22. The system of claim 20, where the similarity between the given term and the plurality of other terms in the set is determined with a Ratcliff/Obershelp function.

23. The system of claim 18, further comprising a web server operable to receive results from the search application and present the results to a user.

24. The system of claim 18, the matching processor further operable to optimize the query with the valid term that best matches the issue term.

25. The system of claim 18, where applying the issue term to the fuzzy network comprises:
identifying one networked term of the plurality of networked terms as a target networked term;
determining a similarity between the issue term and the target networked term using a string distance function;
determining a similarity between the issue term and each neighboring term associated with the target networked term using a string distance function; and
if the issue term is more similar to the target networked term than to any of the neighboring terms of the target networked term, identifying the target networked term as the valid term that best matches the issue term, otherwise, setting a neighboring term that is most similar to the issue term as a new target networked term and repeating for the new target networked term.

26. (canceled)

27. A system for optimizing a query, the system comprising:
a receiving means for receiving an issue term of the query;
an applying means, coupled with the receiving means, for applying the issue term to a fuzzy network, the fuzzy network comprising a plurality of networked terms, each networked term of the plurality of networked terms being associated with one or more neighboring networked terms of the plurality of networked terms; and
an identifying means, coupled with the applying means, for identifying one networked term of the plurality of networked terms as a best match if the issue term is more similar to the one networked term than to any of the neighboring networked terms associated therewith.

28. The system of claim 27, further comprising an optimizing means, coupled with the identifying means, for optimizing the query with the best match.

29. (canceled)

30. The system of claim 27, where each networked term of the plurality of networked terms corresponds with a term from a set of terms.

31-32. (canceled)
